(19) United States
(12) Patent Application Publication
(10) Pub. No.: US 2004/0008467 A1
(43) Pub. Date: Jan. 15, 2004

(54) Safety communication system

(75) Inventors: Jean-Marc Calandre, Callian (FR); Andre Ganier, Rueil-Malmaison (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Schneider Automation, Valbonne (FR)

(21) Appl. No.: 10/460,474

(22) Filed: Jun. 13, 2003

(30) Foreign Application Priority Data
Jun. 18, 2002 (FR) 02 07677

(51) Int. Cl. H02H 1/00

(52) U.S. Cl. 361/119

(57) ABSTRACT

The invention relates to a safety communication system in a automation application (5), comprising a first communication bus (19) on which at least one first safety monitor (12) is connected fitted with several outputs (13), and a second communication bus (29) on which are fitted a second inputs safety module (25), capable of generating a second safety signal, and a second safety monitor (22) receiving said safety signal and fitted with several outputs (23), on the second communication bus (29). Outputs (13) of the first safety monitor (12) are electrically connected to inputs of the second inputs module (25) so as to control at least one output (23) of the second safety monitor (22) as a function of the state of the outputs (13) of the first safety monitor (12).

This invention relates to a safety communication system that circulates safety information on several communication buses of the field bus or sensors/actuators bus type. This safety communication system is particularly suitable for distributed automation applications, particularly in the field of industrial automation system, building automation and monitoring/control of electrical distribution networks.

Field communication buses are now frequently used in distributed automation applications. These automation applications are usually controlled and monitored by one or several automation equipments, such as programmable logic controllers, to which one or several field communication buses are connected, for example through a master communication module. A programmable logic controller controlling all or part of an automation application (sometimes called an automation island) can thus be connected through the bus to automation constituents that are advantageously distributed along the process or the machine to be automated so as to reduce wiring distances and optimise input/output modules in the programmable logic controller.

The use of one or several field communication buses to communicate between automation equipments and constituents is thus a means of considerably simplifying the use and connection of distributed automation constituents. For example these automation constituents include sensors, actuators, speed controllers, automation modules, man/machine dialog constituents such as buttons, switches, lights, displays, etc. These automation constituents are then connected to a communication bus directly through an interface integrated into the constituent, or through standard communication interfaces.

Up to now, safety information obtained from safety constituents such as emergency stop buttons, immaterial safety barriers, access control detectors, etc., were excluded from the communication bus since these safety constituents had to be connected directly by conventional wiring in the power circuit, introducing large extra costs for implementation of the automation application. In the future, due to the increased reliability of information exchanges on field buses, and particularly due to the use of error recognition and error correction mechanisms, it will be possible to connect this type of safety constituents to field communication buses, and this will be an important advantage for covering an increasing number of safety oriented automation applications.

Field communication buses in which it is possible to simultaneously connect safety constituents that cohabit with ordinary modules and constituents, are already available. Thus, all automation constituents distributed in an automation island can connect to master automation equipment through a communication bus. In this type of architecture, there is at least one particular safety constituent called a safety monitor. The safety monitor that is connected to the field bus comprises a specific processing unit that enables it to analyse the form and content of signals circulating on the bus. The safety monitor controls one or several dedicated outputs, for example making it possible to cut off the power to all or some of the machine/process in the case of a fault. In this case, the safety monitor must be capable of triggering its outputs as soon as it detects an error in the various information exchanges circulating on the bus, or a stop order originating from a safety constituent connected to the bus, or a hardware failure of a safety constituent connected to the bus, in order to perform a safety function efficiently.

The AS-i (Actuator Sensor Interface) field bus is a standard field bus, developed by a consortium of manufacturers, that satisfies the EN50295 and IEC62026-2 standards, to connect many types of automation constituents, mainly binary sensor/actuator constituents, to a master module for example located in a programmable logic controller. The reliability of data transmissions on AS-i is such that it is possible to connect ordinary automation constituents and safety constituents on the same AS-i bus so as to make safety oriented automation applications up to level 4 according to the IEC61508 standard, using a standard AS-i bus. To achieve this, at least one safety monitor like that defined above has to be connected to the AS-i bus. The outputs from the safety monitor(s) are configured by a user such that each safety monitor is capable of managing one or several safety constituents connected to the same AS-I bus, without any action by the master coupler of this bus.

However, field buses are usually limited in distance and in the maximum number of constituents that can be connected. These limitations sometimes require the use of several communication buses for complex automation applications, or if they are distributed over long distances. In this type of automation application, it may be desirable to keep safety functions throughout the process or the machine to be automated. For example, this is the case when it is required that action on an emergency stop button located at one end of the machine, should safely stop a motor at the other end. The security of information can only be guaranteed if the complete communication chain is safe and reliable; namely, starting from collection of information on the emergency stop button, as far as the actuator controlling the motor to be stopped.

Consequently, if the distance is too great or if the number of constituents is too large, it is essential to make safety information pass several field buses, through several master modules, or even through several programmable logic controllers connected in a network. This type of solution may then require that different master couplers or programmable logic controllers are made redundant, and/or that specific equipment is used introducing penalising complexities and extra costs.

Therefore, the purpose of the invention is to correct these disadvantages by proposing a simple, easily installed and unexpensive safety communication system capable of carrying safety information on several communication buses of the field bus or the sensors/actuators bus type, without using the master couplers of these buses.

To achieve this, the invention describes a safety communication system in an automation application including a first communication bus to which at least one first safety monitor is connected provided with several outputs controlled by the second safety monitor and a first communication bus to which are connected i) a second safety inputs module provided with several inputs and capable of generating a second safety signal representative of the state of said inputs on the second communication bus, and ii) a second safety monitor that receives said second safety signal and provided with several outputs that can be controlled by the safety monitor on the second as a function of said second safety signal. The system is characterised in that outputs of the first safety monitor are connected to inputs of the second safety inputs module, in order to control at least one output from the second safety monitor as a function of the outputs of the first safety monitor connected to the inputs of the second safety inputs module.

According to one characteristic, two outputs from the first safety monitor are electrically connected to the two corresponding inputs of the second safety inputs module.

Other characteristics and advantages will become clear from the detailed description given below with reference to embodiments given as examples and represented in the attached drawings on which:

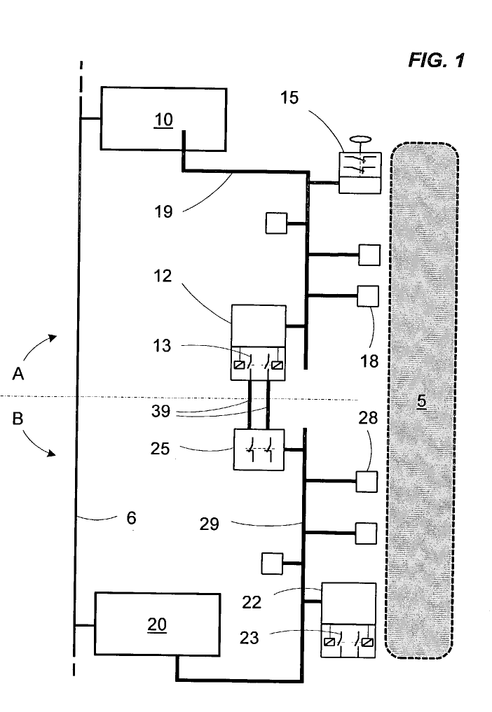

FIG. 1 shows a first example architecture of a communication system according to the invention,

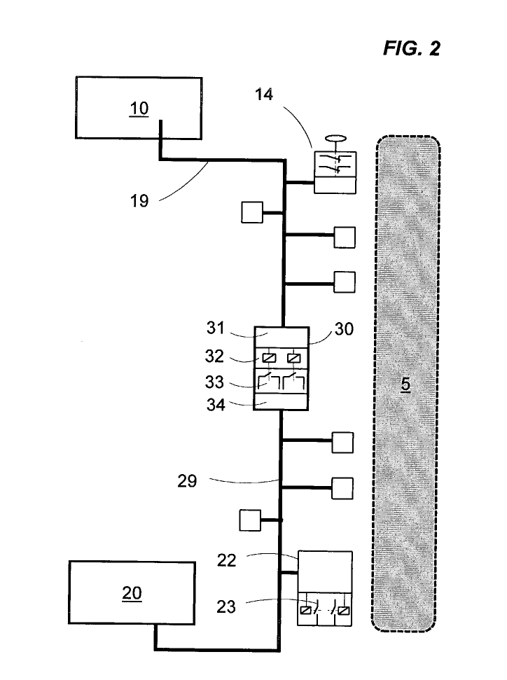

FIG. 2 shows a second example architecture of a communication system according to the invention,

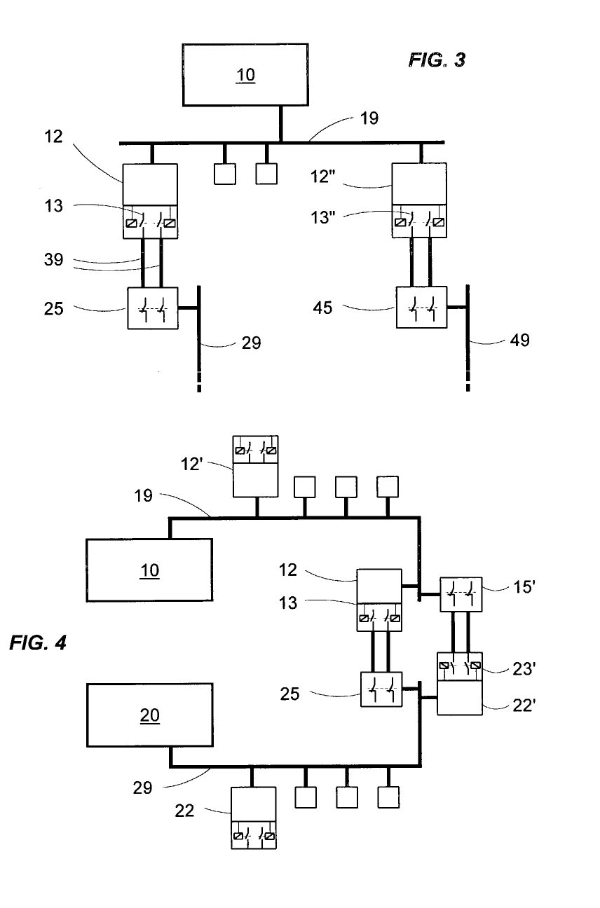

FIGS. 3 and 4 show variants of the first example architecture.

With reference to FIG. 1, a distributed automation application 5 is controlled by two automation islands A and B. This automation application 5 may indifferently belong to the field of industrial automation, building automation, monitoring/control of electrical distribution networks or others. The first automation island A comprises a first programmable logic controller 10 and a first field communication bus 19 connected to the programmable logic controller 10, through a master communication module not shown in FIG. 1. Similarly, the second automation island B comprises a second programmable logic controller 20 and a second field communication bus 29 connected to the programmable logic controller 20 through a master communication module not shown in FIG. 1. Each programmable logic controller 10,20 may comprise several master modules so as to communicate on several field communication buses. Each programmable logic controller 10,20 can also be connected to a communication network 6, of the factory network type, used particularly for communication between islands and for returning information to a central supervision level.

A number of automation constituents 18 and 28 are installed along the automation application 5 to be controlled and are connected to communication buses 19 and 29 respectively, to enable them to exchange information with the master modules of the programmable logic controllers 10 and 20 respectively, thus limiting wiring distances. These automation constituents 18,28 may indifferently include sensors, actuators, speed controllers, automation modules, man-machine dialog constituents, etc., and safety input modules 15,25 such as emergency stop buttons, immaterial safety barriers, access control detectors, etc.

It is known that a safety inputs module is capable of generating a safety signal on a communication bus, representing the state of its inputs. In order to comply with safety standards, a safety inputs module must comprise at least two inputs. In the example of an AS-i field communication bus, this safety signal is composed of an ordered sequence of several four-bit frames that circulate on the bus in an ordered and cyclic manner. The contents of each frame sequence is specific to a determined safety inputs module, such that every receiver of a safety signal is capable of identifying the source of this signal after an initial learning period. Advantageously, safety signals in an AS-i bus may thus cohabit on the same bus with other signals sent by ordinary automation constituents.

A safety monitor is an automation constituent that comprises a processing unit capable of controlling specific safety outputs. The processing unit is capable of receiving safety signals circulating on the communication bus and analysing them to detect an anomaly in the frame sequence in order to control its safety outputs as a function of this analysis. In order to comply with the safety standards, a safety monitor must control at least two safety outputs. The user can configure the system to assign one or several safety input modules to a safety monitor, for example located by means of their physical address on the bus. Moreover, a safety monitor picks up all signals exchanged on the bus so as to be capable of detecting any error in operation of the communication bus. Thus, a safety monitor must be capable of switching off its safety outputs as soon as:

a stop order is detected in the safety signal coming from a safety inputs module assigned to the safety monitor,

an error is detected (in other words an interrupted sequence or an incorrect sequence) in the safety signal coming from a safety inputs module assigned to the safety monitor,

a bus communications error is detected.

A first safety monitor 12 is connected to the first communication bus 19 and is provided with at least two safety outputs 13. According to the embodiment shown in FIG. 1, the safety outputs 13 are both positive safety relay outputs that are integrated in the first safety monitor 12. It would also be possible to envisage safety outputs belonging to a specific safety outputs module connected to the communication bus and dialoguing with the safety monitor through the bus. The first safety monitor 12 controls its safety outputs 13 as a function of settings made initially by the user. A first safety inputs module 15, which is an emergency stop button in the example in FIG. 1, is connected to the first communication bus 19. This first safety inputs module sends a determined sequence of frames as long as the emergency stop button has not been pressed.

A second safety monitor 22 is connected to the second communication bus 29 and is provided with at least two second safety outputs 23. The communication system also includes a second safety inputs module 25 connected to the second of the communication bus 29. The second safety monitor 22 is configured in particular to monitor the second safety inputs module 25.

The purpose of the invention is to be able to transmit safety information generated on the first communication bus 19 to the second communication bus 29. To achieve this, safety outputs 13 of the first safety monitor 12 are connected one by one to inputs of the second safety inputs module 25. Thus, any change in the state of at least one first safety output 13 will cause a state change of the input to the module 25 that is connected to it. Preferably, information remains safe since information is always kept redundant, due to the use of two safety outputs 13 of the first safety monitor 12 respectively connected to two inputs of the second safety inputs module 25. According to the embodiment shown in FIG. 1, the safety outputs 13 are electrically cabled through a wire link 39 to the inputs of the second safety inputs module 25.

For example, if the first safety monitor 12 is configured to monitor the first safety inputs module 15, then when the emergency stop button is pressed, the first safety inputs modules 15 transmits this information on the first communication bus 19 by modifying the safety signal received by the first safety monitor 12. The first safety monitor 12 then triggers at least one of its safety outputs 13 which consequently causes a change to the state of the inputs to the corresponding second safety inputs module 25. The second safety inputs module 25 sends this information to the second communication bus 29 by modifying the safety signal that will be received by the second safety monitor, which can then trip at least one of its second safety outputs 23.

Thus, pressing on an emergency stop button connected to a first communication bus will safely cause an automatic trip of the outputs connected to a second communication bus. Similarly, it will be possible to envisage that the first safety monitor 12 should be configured to be able to monitor any other safety constituent connected to the first communication bus 19.

In the variant shown in FIG. 3, for example in which the automation application 5 is managed by more than two automation islands, it is required to make safety information transit through a first communication bus 19 to several second communication buses 29,49. This is done by connecting an additional first safety monitor 12″ onto the first communication bus 19. This additional monitor 12″ controls its outputs 13″ that are connected through a wire link to the inputs of a safety inputs module 45 connected to the communication bus 49. Obviously, the invention could also be used to transit the same safety information on several communication buses chained in cascade. To achieve this, all that is necessary is to connect the outputs of a second safety monitor 23 to the inputs of a safety inputs module connected to a third communication bus, and so on.

In the variant shown in FIG. 4, it is required to pass safety information in two directions, not only from the first communication bus 19 to the second communication bus 29 as in the example in FIG. 1, but also from the second communication bus 29 to the first communication bus 19. To achieve this, an addtional second safety monitor 22′ is connected to the second communication bus 29 and controls its outputs 23′. A first safety inputs module 15′ comprising several inputs is connected to the first communication bus 19 and is capable of generating a first safety signal on the bus representative of the state of its inputs. The outputs 23′ of the addtional second safety monitor 22′ are connected to the corresponding inputs of the second safety inputs module 15′ in order to control at least one output 13′ of a second safety monitor 12′, connected to the first communication bus 19 as a function of the state of the outputs 23′ connected to the inputs of the first safety inputs module 15′.

The architecture shown in FIG. 2 describes another embodiment of the safety communication system, with the same characteristics as the architecture in FIG. 1. This embodiment comprises a safety repeater 30 provided with connections on the first communication bus 19 and on the second communication bus 29. The safety repeater 30 integrates the functions of a first safety monitor 12 with its safety outputs 13 and a second safety inputs module 25, in the same housing. It comprises a first stage 31 that performs the function of a safety monitor connected to the first communication bus 19 and that controls two internal outputs 32. These outputs are connected one by one to the inputs 33 of a second stage 34 that performs the function of a safety inputs module connected to the second communication bus 29. The internal outputs 32 are indifferently made using a relay outputs, optoelectronic outputs, infrared outputs technology, or another technology, such that the safety repeater 30 can achieve galvanic isolation between the two field communication buses 19 and 29. Thus, with this type of safety repeater 30 designed in the same housing and provided with two connection ports, a safety communication system according to the invention can advantageously be simplified so as to transmit safety information between a first and a second field communication bus, for example of the AS-i type.

Obviously, it would be possible to imagine other variants and improvements to detail and even to envisage the use of equivalent means, without going outside the framework of the invention.

1. Safety communication system in a automation application (5), comprising
a first communication bus (19) on which at least one first safety monitor (12) is connected fitted with several outputs (13) controlled by the first safety monitor (12),
a second communication bus (29) on which are connected a second safety inputs module (25) fitted with several inputs and capable of generating on the second communication bus (29) a second safety signal representative of the state of said inputs, and a second safety monitor (22) receiving said second safety signal and fitted with several outputs (23) that can be controlled by the second safety monitor (22) as a function of said second safety signal,
characterised in that outputs (13) of the first safety monitor (12) are connected to inputs of the second safety inputs module (25) so as to control at least one output (23) of the second safety monitor (22) as a function of the state of the outputs (13) of the first safety monitor (12) connected to the inputs of the second safety inputs module (25).

2. Safety communication system according to claim 1, characterised in that two outputs (13) of the first safety monitor (12) are electrically connected respectively to two inputs of the second safety inputs module (25).

3. Safety communication system according to claim 1, characterised in that the first safety monitor (31) and the second safety inputs module (34) are integrated in a safety repeater (30) comprising a common housing connected to the first communication bus (19) and to the second communication bus (29).

4. Safety communication system according to claim 1, characterised in that a first safety inputs module (15), connected to the first communication bus (19) and fitted with several inputs, is capable of generating on the first communication bus (19) a first safety signal representative of the state of said inputs, the first safety signal being received by the first safety monitor (12) to control the outputs (13) of the first safety monitor (12).

5. Safety communication system according to claim 1, comprising
at least one additional second safety monitor (22′) connected to the second communication bus (29) and fitted with several outputs (23′) controlled by the additional second safety monitor (22′),
a first safety inputs module (15′) connected to the first communication bus (19), fitted with several inputs and capable of generating a first safety signal on the first communication bus (19) representative of the state of said inputs,
a first safety monitor (12′) connected to the first communication bus (19), receiving said first safety signal and comprising several outputs (13′) that can be controlled by the first safety monitor (12′) as a function of said first safety signal,
characterised in that outputs (23′) of the additional second safety monitor (22′) are connected to inputs of the first safety inputs module (15′) so as to control at least one output (13′) of the first safety monitor (12′) as a function of the state of the outputs (23′) of the additional safety monitor (22′) connected to the inputs of the first safety inputs module (15′).

6. Safety communication system according to claim 1, comprising several first safety monitors (12,12″) connected to the first communication bus (19) and comprising several second communication buses (29,49) on each of which are connected a second safety inputs module (25,45) and a second safety monitor, characterised in that the outputs (13,13″) of each first monitor (12,12″) are respectively connected to the inputs of the second inputs module (25,45) of each second communication bus (29,49) so as to control at least one output of each second monitor as a function of the state of the outputs (13,13″) of the first monitors.

7. Safety communication system according to one of the preceding claims, characterised in that the safety signals generated by second and first safety inputs modules are composed of an ordered sequence of several frames, specific to each safety inputs module.

8. Safety communication system according to one of the preceding claims, characterised in that the first communication bus (19) and the second communication bus(es) (29,49) are AS-i buses.
